(19) United States
(12) Patent Application Publication
(10) Pub. No.: US 2007/0165491 A1
(43) Pub. Date: Jul. 19, 2007

(54) Sound recording device for use in vehicles

(76) Inventor: Shih-Hsiung Li, Taipei (TW)

Correspondence Address: COOPER & DUNHAM, LLP, 1185 AVENUE OF THE AMERICAS, NEW YORK, NY, 10036, US

(21) Appl. No.: 11/335,322

(22) Filed: Jan. 19, 2006

(51) Int. Cl. H04B 1/20

(52) U.S. Cl. 369/1

(57) ABSTRACT

A vehicle on-board sound recording device includes a carrier with a sound recording module. The sound recording module includes a microprocessor, a memory, a microphone, a mini speaker, an indicator unit and a plurality of operation buttons. The microprocessor is used as an operation control center with a built-in compress program to make a compressed audio file. The memory is used as a storage media. The microphone is used to receive a driver's sound message and send to the microprocessor. The mini speaker is used to play the sound message of digital/analog conversion. The operation buttons and the indicator unit are configured on a surface of the carrier to facilitate the driver to manipulate, so that the driver not only can record important sound message but also can have a safe driving.

### BACKGROUND OF THE INVENTION

1. Field of the Invention

The invention relates in general to a sound recording device for use in vehicles, and more particularly to a sound recording device that a driver can record important sound messages while driving.

2. Description of the Related Art

More and more people communicate over mobile phones even when driving cars in the busy society nowadays. Vehicle on-board mobile phones are available on the basis of safe driving. Thereby drivers can directly use the vehicle on-board mobile phones when driving the cars. However, when the drivers need to keep down some important information during the communication over the mobile phone, it may be risky for the drivers to be distracted to try to write down or memorize the information when the drivers are still driving.

A practicable method for the drivers to keep down the important information can be to use a sound recording manner. The drivers can use a recording equipment to store the important message during the communication over the mobile phone by repeatedly reciting, and then play the recorded message later to write down the message when getting off the cars. In this way, the drivers not only can keep the important message but also can ensure the safe driving. Since the recording equipment is used on the cars, many factors of the recording equipment should be taken into consideration.

First of all, the recording equipment should be small sized. There is no vehicle on-board recording device in the conventional recording equipment products, let alone a reserved space inside the cars for the recording equipment.

Secondly, the recording equipment should be convenient and easy to operate for the drivers. The conventional common recording equipment such as a tape recorder uses a tape as a recording media. The tape can not play in a segmented mode, which is a drawback for the drivers to listen to the information.

In addition, the conventional recording equipment is not suitable for a vehicle on-board characteristic and also is inconvenient to manipulate when the drivers are driving. Hence the conventional recording equipment can be further improved to facilitate the drivers to use.

### SUMMARY OF THE INVENTION

An objective of the present invention is to provide a small sized sound recording device, which is convenient for a driver to record sound messages during driving. In order to achieve the aforesaid objective, the sound recording device includes a carrier with a sound recording module inside the carrier. The sound recording module is used to record or replay sound. The sound recording module includes a microprocessor, a memory, a microphone, a mini speaker, an indicator unit and a plurality of operation buttons.

The microprocessor is used as an operation control center with a built-in compress program to make a compressed audio file. The memory is coupled with the microprocessor to be used as a storage media for the compressed audio file. The memory is a flash memory of high capacity. The microphone is configured on an input terminal of the microprocessor used for sound pick-up for receiving a driver's sound message and sending to the microprocessor. Furthermore, the microphone is coupled to the microprocessor via an analog-to-digital converter. The analog-to-digital converter also can be built in the microprocessor. The mini speaker configured on a sound output terminal of the microprocessor via a digital-to-analog converter is used to play the sound message of digital/analog conversion outputted by the microprocessor. The digital-to-analog converter also can be built in the microprocessor. The indicator unit is configured on an output terminal of the microprocessor to display current working status of the sound recording device. The indicator unit is made up by a plurality of LEDs (light-emitting diodes) to display in a segmented mode. Besides, the indicator unit also can be made by a LCD (liquid crystal display) to direct display the current working status of the sound recording device on a frame. The operation buttons are respectively configured on each of the input terminals of the microprocessor for executing sound recording, broadcasting and deletion.

Moreover, the carrier forms a flat-shaped cassette structure, which is compact and small sized, so as to be able to be installed near the driver's seat to facilitate the driver to manipulate. Besides, the carrier also can be a rear-view mirror near the driver's seat or an extending casing formed on a top of a rear-view mirror near the driver's seat.

Since the sound recording device of the present invention is compact and small-sized, the sound recording device can be fixed inside the car near the driver's seat to facilitate the driver to manipulate. Hence the sound recording device is very easy and convenient for the driver to use. By using the sound recording device, the driver not only can record important sound message but also can have a safe driving when manipulating the sound recording device.

### BRIEF DESCRIPTION OF THE DRAWINGS

FIG. 1 is circuit block diagram of a first embodiment of the present invention.

FIG. 2 is a front view of the first embodiment of the present invention.

FIG. 3 is an operational view of the first embodiment being mounted in a car.

FIG. 4 is a circuit block diagram of a second embodiment of the present invention.

FIG. 5 is a front view of the second preferred embodiment of the present invention.

FIG. 6 is an operational view of a first example that the present invention is integrated to a rear-view mirror.

FIG. 7 is an operational view of a second example that the present invention is integrated to a rear-view mirror.

FIG. 8 is an operational view of a third example that the present invention is integrated to a rear-view mirror.

### DETAILED DESCRIPTION OF THE INVENTION

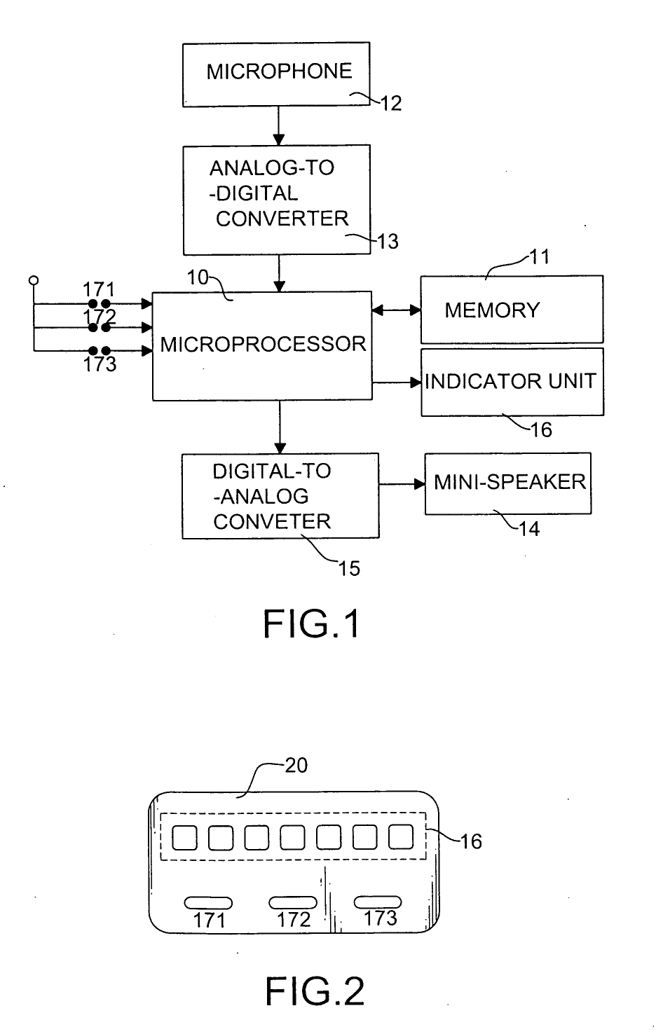

The present invention is to provide a carrier configured with a sound recording module inside the carrier. The sound recording module is used to record or replay sound. With reference to FIG 1, the sound recording module in a first preferred embodiment of the present invention includes a microprocessor 10, a memory 11, a microphone 12, a mini speaker 14, an indicator unit 16 and a plurality of operation buttons 171, 172 and 173.

The microprocessor 10 is used as an operation control center with a built-in compress program to make a compressed audio file. The memory 11 is coupled with the microprocessor 10 to be used as a storage media for the compressed audio file. In this preferred embodiment, the memory 11 is a flash memory of high capacity. The capacity of the conventional flash memory can be more than 1 G, which is an ideal option of the storage media of small volume with high capacity, so as provide sufficient storage space for the compressed audio files.

The microphone 12 is configured on an input terminal of the microprocessor 10 used for sound pick-up for receiving a driver's sound message and sending to the microprocessor 10. In this preferred embodiment, the microphone 12 is coupled to the microprocessor 10 via an analog-to-digital converter 13. The analog-to-digital converter 13 also can be built in the microprocessor 10.

The mini speaker 14 is used to play the sound message of digital/analog conversion outputted by the microprocessor 10. In this preferred embodiment, the mini speaker 14 is configured on a sound output terminal of the microprocessor 10 via a digital-to-analog converter 15.

The indicator unit 16 is configured on an output terminal of the microprocessor 10 to display current working status of the sound recording device. In this preferred embodiment, the indicator unit 16 is made up by a plurality of LEDs (light-emitting diodes) to display in a segmented mode. For example, the indicator unit 16 can show current recording records or current operating file on the sound recording device. Besides, the indicator unit 16 also can be made by a LCD (liquid crystal display) to direct display the current working status of the sound recording device on a frame.

The operation buttons 171, 172 and 173 are respectively configured on each of the input terminals of the microprocessor 10 for executing sound recording, broadcasting and deletion.

A concrete structure of core technique of the present invention can be understood from the above description. The sound recording module can be configured inside the carrier. In the first preferred embodiment of the present invention, the carrier is a cassette structure. With reference to FIG. 2, the cassette carrier 20 can be flat-shaped of a business card size, which is suitable to be fixed on multiple appropriate positions inside a car. The operation buttons 171, 172 and 173 and the indicator unit 16 are configured on a surface of the carrier 20 to facilitate the driver to manipulate.

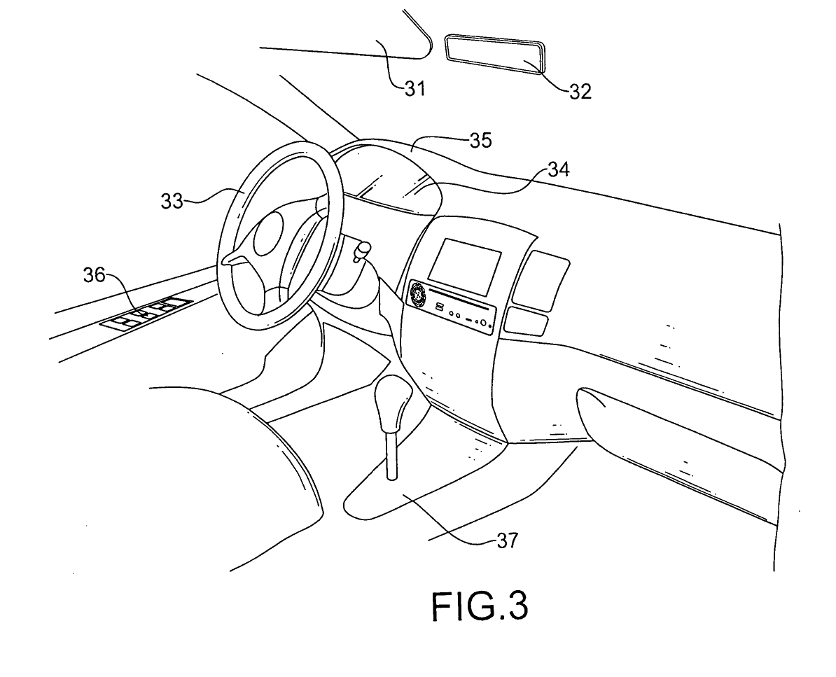

The sound recording device is provided for the driver to manipulate, so that the sound recording device is installed near the driver's seat. With reference to FIG. 3, a practicable installation diagram shows several appropriate positions for installing the sound recording device. The position 31 on a sun-shading board at an inner side of a windscreen is located above the head of the driver, so that the driver can manipulate the sound recording device simply by raising the hand. The position 32 on the rear-view mirror is near the driver's seat, so as to facilitate the driver to manipulate. Further, the position 33 is on a steering wheel. Since the sound recording device of the present invention is compact of a small size, so as to be able to be fixed on the steering wheel. Hence the driver can manipulate the sound recording device very easily when driving the car.

Moreover, the position 34 is on an instrument board, which is in front of the driver, so that the driver can manipulate the sound recording device easily. Besides, the position 35 is located on a panel above the instrument board, which is also handy for the driver to manipulate.

Furthermore, a position 36 on a control buttons at an inner side of a car door next to the driver is also very convenient for the driver to manipulate the sound recording device. Besides, the positions at a handrail inside the car door and the handrail of the driver's seat (not shown in the diagram) and the position 37 at a gear lever are also convenient locations for the driver to install the sound recording device.

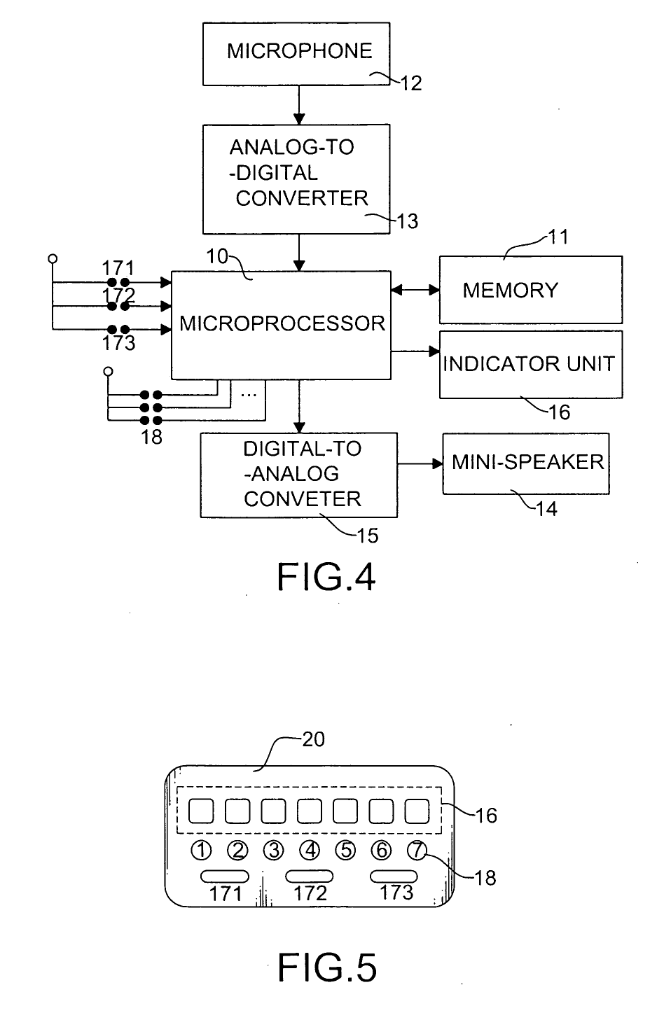

In addition, with reference to FIG. 4, a block diagram of a second preferred embodiment of the present invention includes the similar structure of the first preferred embodiment. A main difference of the second preferred embodiment is that the microprocessor 10 is further coupled to a plurality of address buttons 18. Each of the address buttons 18 is respectively corresponding to different storage space of the memory 11. The address buttons 18 are configured on the surface of the carrier as shown in FIG. 5, which is provided for the driver to direct choose the storage space to save or to delete the file. A concrete operation method is described as follows:

Sound recording: one of the address buttons 18 on the carrier 20 is pressed, so as to assign a memory address for storing the audio file. Then the operation button 171 is pressed to start the sound recording. Hence the recorded digital compressed audio file is saved in the assigned memory address.

Broadcasting: one of the address buttons 18 on the carrier 20 is pressed, so as to assign the specific memory address stored with the digital compressed audio file for playing the audio file. Then the operation button 172 is pressed to start playing the audio file.

Deletion: one of the address buttons 18 on the carrier 20 is pressed, so as to assign the memory address for deleting the audio file. Then the operation button 173 is pressed to delete the digital compressed audio file stored in the specified memory address.

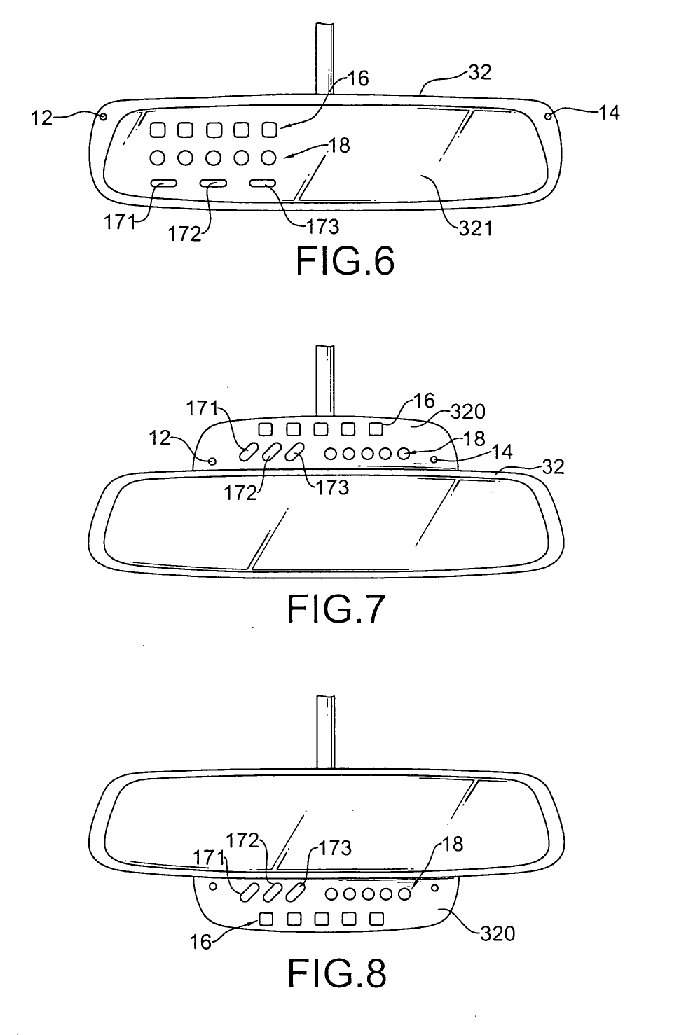

In the above-described preferred embodiments of the present invention, the carrier 10 is an independent cassette structure, and also the vehicle on-board sound recording device is also an independent from, so as to be able to be installed at the aforesaid appropriate positions. Moreover, the vehicle on-board sound recording device also can be integrated to other equipment inside the car. With reference to FIG. 6, a practicable installation diagram of a first example that the present invention is integrated to a rear-view mirror 32 is shown. The aforesaid carrier is an external casing of the rear-view mirror 32. The operation buttons 171, 172, and 173 for the sound recording, boarding, and deletion of the sound recording device are exposed on a surface of a mirror 321 of the rear-view mirror 32. In addition, if sensor buttons are applied in the present invention, the operation buttons 171, 172, and 173 and the address buttons 18 can be hidden inside the mirror 321. The microphone 12 and the mini speaker 14 are installed at a rim of the rear-view mirror 32.

When the sound recording device is in a standby mode, the indicator unit 16 does not display. When the driver needs to use the sound recording device, the indicator unit 16 displays as long as the driver presses any operation button. Then the current working status is shown on the mirror 321 of the rear-view mirror 32.

With reference to FIG. 7 and FIG. 8, two practicable installation diagrams of a second example and a third example that the present invention is integrated to a rear-view mirror are shown. The carrier is an extending casing 320 formed on a top rim or a bottom rim of the rear-view mirror 32. The sound recording module is configured inside the extending casing 320. The microphone 12, the mini speaker 14, the indicator unit 16, the operation buttons 171, 172 and 173 and the address buttons 18 are all configured at the surface of the extending casing 320, so as to facilitate the driver to manipulate.

Therefore, the present invention provides the vehicle on-board sound recording device having the small size and sufficient storage capacity for storing the audio files. Since the sound recording device is compact and small-sized, the sound recording device can be fixed inside the car near the driver's seat to facilitate the driver to manipulate. Hence the sound recording device is very easy and convenient for the driver to use. By using the sound recording device, the driver not only can record important sound message but also can have a safe driving when manipulating the sound recording device. Thereby the vehicle on-board sound recording device of the present invention indeed includes features of good utility and unobviousness, so as to meet the requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sound recording device for use in vehicles, the device comprising:
a carrier;
a sound recording module configured inside the carrier to record or replay sound;
the sound recording module comprising:
a microprocessor used as an operation control center with a built-in compress program to make a compressed audio file;
a memory coupled with the microprocessor to store the compressed audio file;
a microphone connected to an input terminal of the microprocessor to receive a driver's sound message and send the sound message to the microprocessor;
a mini speaker connected to a sound output terminal of the microprocessor to play digital to analog converted sound message;
an indicator unit configured on an output terminal of the microprocessor to display current working status of the sound recording device; and
multiple operation buttons respectively connected to input terminals of the microprocessor for executing sound recording, broadcasting and deletion; wherein the indicator unit and the operation buttons are mounted on a surface of the carrier to facilitate the driver to manipulate.

2. The device as claimed in claim 1, wherein the indicator unit is made up by LEDs (light-emitting diodes) to display in a segmented mode.

3. The device as claimed in claim 1, wherein the indicator unit is made up by an LCD (liquid crystal display).

4. The device as claimed in claim 1, wherein an analog-to-digital converter is connected between the microprocessor and the microphone.

5. The device as claimed in claim 4, wherein the analog-to-digital converter is built in the microprocessor.

6. The device as claimed in claim 1, wherein a digital-to-analog converter is configured between the mini speaker and the microprocessor.

7. The device as claimed in claim 1, wherein the memory is a flash memory.

8. The device as claimed in claim 1, wherein address buttons are configured on the input terminal of the microprocessor for the driver to choose a file space to record the sound, to play or to delete the file.

9. The device as claimed in claim 1, wherein the carrier is a flat-shaped cassette.

10. The device as claimed in claim 1, wherein the carrier is a rear-view mirror near the driver's seat.

11. The device as claimed in claim 1, wherein the carrier is an extending casing formed on a top of a rear-view mirror near the driver's seat.
